(19) United States
(12) Patent Application Publication
(10) Pub. No.: US 2026/0264623 A1
(43) Pub. Date: Sep. 10, 2026

(54) MOUNT FOR VEHICLE MEDIA DEVICE

(71) Applicant: NAMSUNG CORPORATION, Seoul (KR)

(72) Inventor: Seong-Ho YOON, Seoul (KR)

(21) Appl. No.: 19/266,625

(22) Filed: Jul. 11, 2025

(30) Foreign Application Priority Data
Mar. 7, 2025 (KR) 10- 2025-0029390

(51) Int. Cl. B60R 11/02; B60R 11/00

(52) U.S. Cl. CPC B60R 11/0252; B60R 11/0211; B60R 11/0241; B60R 11/0258; B60R 2011/0005; B60R 2011/005

(57) ABSTRACT

A mount for a vehicle media device is provided, which allows a user to simply hold and use a media device usable in a vehicle such as a navigation, a PMP, or a smartphone, and includes: a dashboard mount 100; a fixing bracket 200 connected to the rear of the dashboard mount 100 to be able to rotate, having a lower portion inserted and fixed in a gap between a front glass of the vehicle and the dashboard, and having an upper portion closely fixed to the front glass; and a hold mount 300 connected to the front of the dashboard mount 100 to hold a media device 340.

### CROSS-REFERENCE TO RELATED APPLICATION

This application claims priority to Korean Patent Application No. 10-2025-0029390, filed on Mar. 7, 2025, the disclosure of which is incorporated herein by reference in its entirety.

### BACKGROUND OF THE INVENTION

### 1. Field of the Invention

The present invention relates to a mount for a vehicle media device, and more specifically, to a mount for a vehicle media device, which enables a user to simply hold and use a media device usable in a vehicle such as a navigation, a portable multimedia player (PMP), or a smart phone, etc.

### 2. Description of Related Art

In general, a media device is capable of watching a video or listening to music or a radio, and in recent years, the distribution of portable devices that a user can easily carry has been greatly increased.

The portable media device may include an MP3 player, a portable multi-media player (hereinafter, referred to as a Portable multimedia player (PMP)), a smart phone, a tablet computer (Tablet PC), and the like.

In addition, a navigation system for guiding a driver to a destination to which the driver wants to go is mounted and used inside the vehicle.

As described above, in recent years, a desire to use a portable media device having a greatly increased supply in a vehicle is increasing, and a separate holder for a media device is required in order to mount and use the portable media device and a media device such as a navigation device in the vehicle.

A mount for a vehicle media device is fixed to a front glass of a vehicle by using a suction plate, or fixed to a dashboard by using an adhesive sheet such as a double-sided tape or a piece bolt.

However, the structure of fixing the mount for a vehicle media device to the front glass of the vehicle by the suction plate obstructs the driver's view during driving, and when the holder is separated from the glass plate, an afterimage may remain on the portion where the suction plate is attached to the front glass of the vehicle, and the suction state may be released by the self-load of the mounted media device, so that the holder may be easily separated.

Especially, the structure for fixing the mount for a vehicle media device to the front glass of the vehicle by the suction plate releases the suction state due to the self-load of the mounted media device caused by the deterioration of the suction performance of the suction plate in the winter, thereby causing the risk of traffic accidents and the damage to the mounted media device during the operation.

Further, in a structure in which the mount for a vehicle media device is fixed to the dashboard using a fastening means, such as an adhesive sheet, a piece bolt, or the like, a fastening hole or the like of an adhesive mark, a piece bolt, or the like, is left on the dashboard, thereby deteriorating the appearance of the vehicle and preventing the holder from being easily detached.

In addition, when a holder is installed in a space between the front glass and the dashboard of the vehicle, there is a problem in that the holder is popped out according to the strength of the spring.

In addition, when the inclination angle of the front glass of the vehicle is very small, there is a problem in fixing the holder because a human hand is not included when installing the holder.

### SUMMARY OF THE INVENTION

An object of the present invention is to provide a mount for a vehicle media device in which the holder can be stably fixed between a front glass and a dashboard of the vehicle.

According to an aspect of the present invention, there is provided a mount for a vehicle media device, the holder including: a dashboard mount; a fixing bracket rotatably connected to a rear side of the dashboard mount, a lower portion of the fixing bracket being inserted and fixed to a gap between a front glass of the vehicle and the dashboard, and an upper portion of the fixing bracket being closely fixed to the front glass; and a hold mount connected to a front side of the dashboard mount to hold the media device.

The dashboard mount may include: a body having a predetermined length; connection covers 120 and 130 connecting a rear side of the body and one side of the fixing bracket; and a connector configured to detachably connect a front side of the body and the hold mount.

The body is characterized in that it has flexibility to be bent in the vertical direction.

The body is characterized in that the flexible metal is embedded therein and rubber or silicone is covered on the outside.

The connection covers 120 and 130 may include: an upper cover enclosing a rear upper surface and both side surfaces of the body; and a lower cover adhered to a rear lower surface of the body and coupled to a lower part of the upper cover.

The upper cover and the lower cover may be coupled by a plurality of fastening screws fastened to the lower part of the lower cover.

A support part connecting the lower surface of the body and the lower rear part of the media device is installed.

The support part may include: a cable connected along a length direction of a lower surface of the body; and a head formed at a front side of the cable and supporting a lower portion of a rear of the media device.

The fixing bracket may include: a fixing member having a lower portion inserted and fixed in a gap between the front glass and the dashboard of the vehicle; a pair of left and right window contact members rotatably installed on the left and right sides, respectively, at a height intermediate to the fixing member to be in close contact with the front glass; and a rotating member rotatably installed on a center front side at a height intermediate to the fixing member to be connected to the rear of the connection covers 120 and 130 via a connection member.

The fixing member may further include a pair of left and right fixing members formed to be horizontal from the left and right sides of the vertical upper end of the fixing member to the front; and a second fixing member formed to be vertical upward between the pair of left and right first fixing members with respect to the vertical upper end of the fixing member.

A left side and a right side of a lower front portion of the second fixed member and a rear portion of the rotating member may be connected via a second hinge pin, and a front portion of the rotating member and a rear portion of the connecting member may be connected by screwing.

Lower front portions of the pair of left and right window contact bars and rear portions of the upper surface of the fixing member may be connected to left and right sides via first hinge pins, and the pair of left and right window contact bars may be elastically supported to be rotated from the fixing member toward the front glass by springs wound on outer circumferences of the first hinge pins on left and right sides, respectively.

The spring may be characterized in that one end thereof is connected to the left and right sides of the upper end of the fixing member, respectively, and the other end thereof is connected to the front surfaces of the pair of left and right window contact stands.

At least one additional connection member may be connected to a front side of the connection member in a form of a T-shaped convexo-concave structure so as to be inserted and fixed into the connection covers 120 and 130.

The mount for a vehicle media device according to the present invention has a structure in which a lever is extended and inserted into a slight gap portion formed between the front glass and a dashboard of a vehicle, so that a driver can push the holder toward the front glass in a state where the lever is inserted into the gap portion, thereby enabling the holder to be stably fixed between the front glass and the dashboard by a spring force.

### BRIEF DESCRIPTION OF THE DRAWINGS

FIG. 1 is an exemplary view illustrating a state in which a dashboard mount unit of a mount for a vehicle media device according to the present disclosure and various types of hold mounts are separated;

FIG. 2 is an exemplary view illustrating a separation state of a dashboard mount part, a fixing bracket, and a magnetic fixing mount of a mount for a vehicle media device according to the present disclosure;

FIGS. 3 and 4 are exemplary views illustrating a coupled state of a mount for a vehicle media device according to various directions of the present disclosure.

FIG. 5 is an exemplary view illustrating a state in which the fixing bracket according to the present disclosure is viewed in various directions;

FIG. 6 is an exemplary view illustrating a state in which a mount for a vehicle media device according to the present disclosure is mounted between a front glass and a dashboard of the vehicle, and a media device is held therein.

### DETAILED DESCRIPTION OF THE INVENTION

Hereinafter, in order to fully understand the present disclosure, preferred embodiments of the present disclosure will be described with reference to the accompanying drawings. The embodiments of the present invention may be modified into various forms, and the scope of the present invention should not be construed as being limited to the embodiments described in detail below. It should be noted that the same configuration in each drawing may be shown with the same reference numerals. A detailed description of known functions and configurations that may unnecessarily obscure the subject matter of the present disclosure will be omitted.

In the present specification, the front and the rear are defined as the direction closer to the driver and the direction farther away from the driver from the body 100 respectively. Therefore, the front glass of the vehicle is located at the rear, which is farther away from the body, as viewed from the driver.

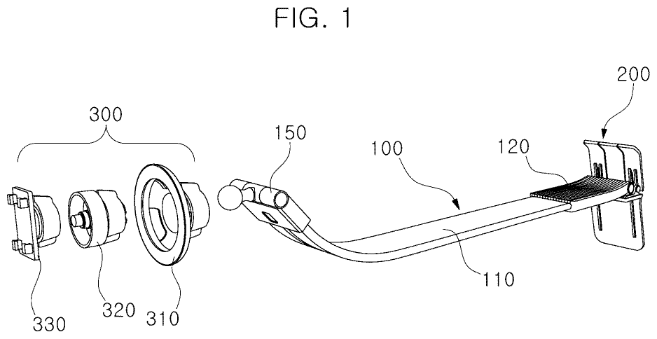

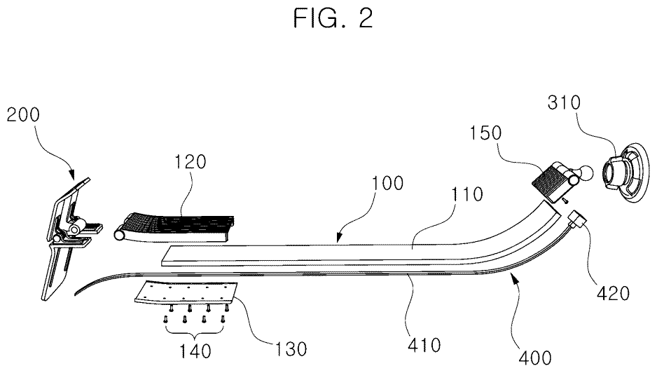

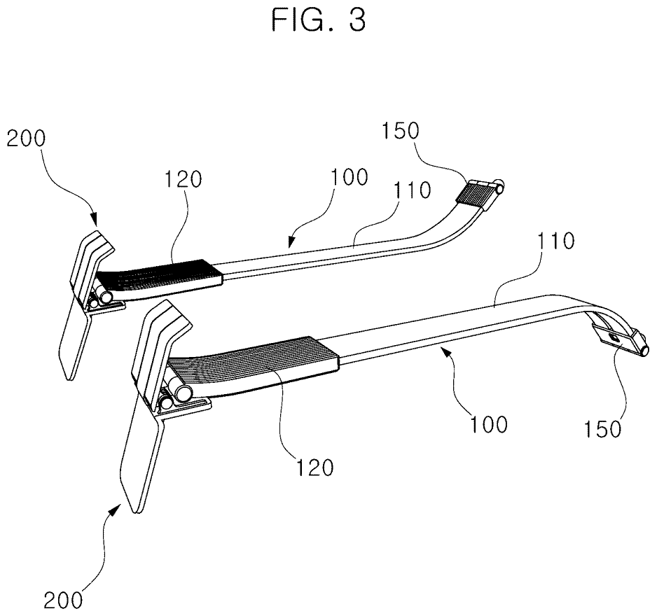

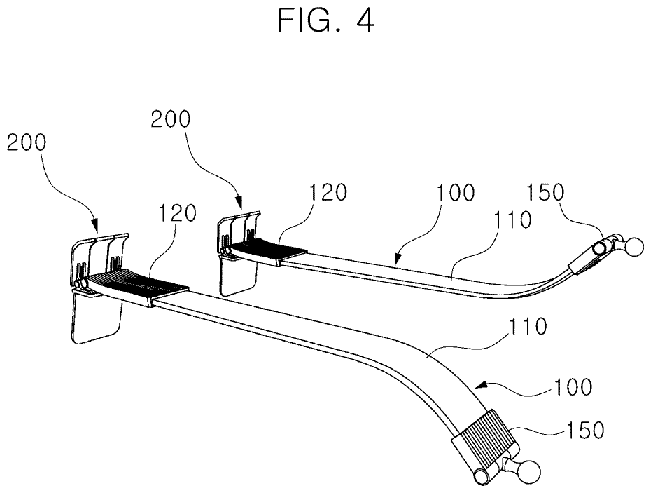

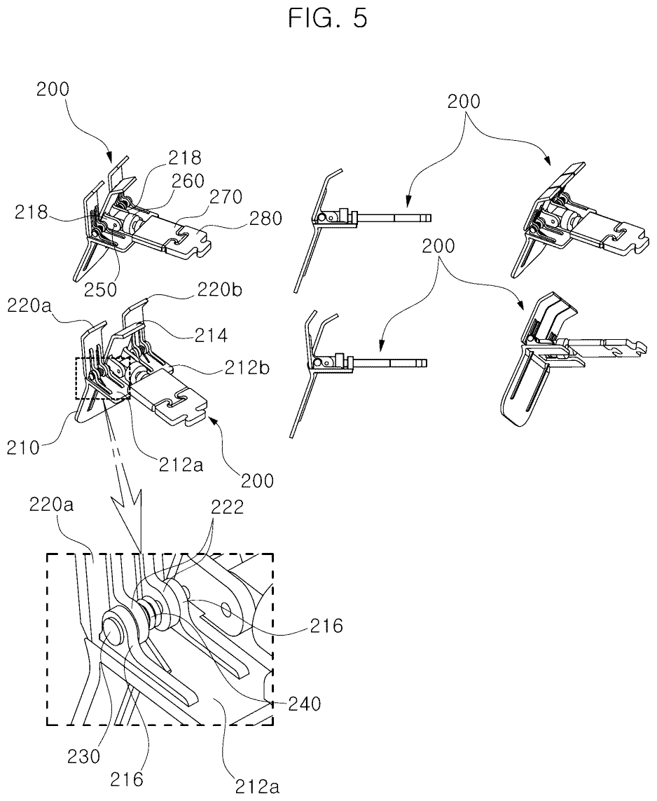

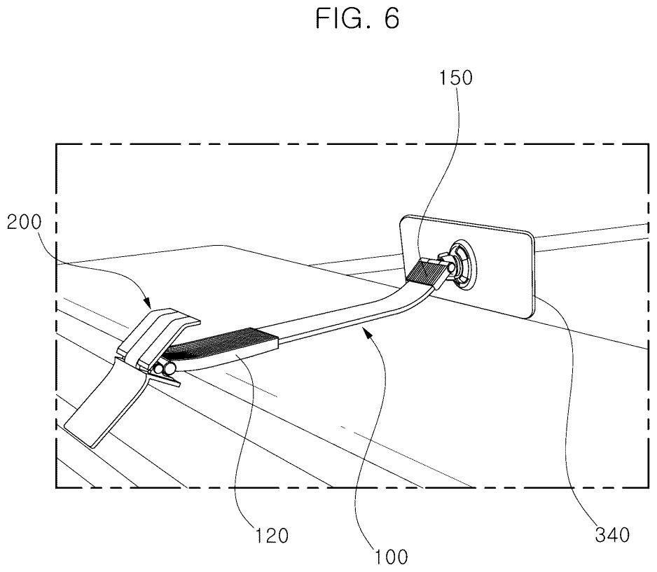

Referring to FIGS. 1 to 6, a mount for a vehicle media device according to an embodiment of the present disclosure includes a dashboard mount 100, a fixing bracket 200, a hold mount 300, and a support part 400.

That is, the dashboard mount 100 includes a body 110, connection covers 120 and 130, and a connector 150.

In this case, the body 110 is formed flat to have a predetermined length to have flexibility bent in a vertical direction, and may be configured to have a structure in which a flexible metal is embedded therein and rubber or silicon is covered on the outside thereof.

The connection covers 120 and 130 serve to connect the rear side of the body 110 and one side of the fixing bracket 200, and are composed of an upper cover 120, a lower cover 130, and a plurality of fastening screws 140.

In this case, the upper cover 120 serves to enclose an upper and both side surfaces of the rear portion of body 110.

The lower cover 130 is in close contact with the lower surface of the rear portion of the body 110 and serves to be coupled to the lower portion of the upper cover 120.

The plurality of fastening screws 140 may be fastened to the lower portion of the lower cover 130 to couple the rear portions of the upper cover 120 and the lower cover 130, or the rear portions of the upper cover 120, the lower cover 130, and the body 110 to each other.

The connector 150 serves to detachably connect the front of the body 110 and the hold mount 300 to each other.

The fixing bracket 200 is rotatably connected to the rear side of the dashboard mount 100, has a lower portion inserted into a gap between the front glass and the dashboard of the vehicle, and has an upper portion closely fixed to the front glass, and includes a fixing member 210, a pair of left and right window contact portions 220a and 220b, a first hinge pin 230, a spring 240, a second hinge pin 250, a rotating member 260, a connection member 270, and an additional connection member 280. The additional connection member 280 may further extend the length from the connection member 270 toward the driver in the front direction, and the front end of the additional connection member 280 has a protrusion shape having a wide front and a narrow rear. The same protrusion shape is formed at the front end of the connection member, and the protrusion shape is inserted and fixed into the concave shape formed at the rear end of the additional connection member 280. That is, the length from the connection member 270 to the body may be adjusted using a plurality of additional connection members 280.

The fixing member 210 has a lower portion inserted and fixed into a gap between the front glass and the dashboard of the vehicle, and includes a pair of left and right first fixing members 212a and 212b formed to be horizontally forward from the left side and the right side of the vertical upper end of the fixing member 210, and a second fixing member 214 formed to be vertical to the upper side between the pair of left and right first fixing members 212a and 212b with respect to the vertical upper end of the fixing member 210.

Here, it is preferable that the left side and the right side of the lower front portion of the second fixing member 214 and the rear portion of the rotating member 260 are connected through a second hinge pin 250, and the front portion of the rotating member 260 and the rear portion of the connecting member 270 are connected by screwing.

The pair of left and right window contact bars 220a and 220b are rotatably installed on the left and right sides at an intermediate height of the fixing member 210, respectively, and serve to be in close contact with the front glass.

In this case, it is preferable that the lower front portion of the pair of left and right window contact bars 220a and 220b and the rear portion of the upper surface of the fixing member 210 are connected to the left and right sides by means of a first hinge pin 230.

The left and right window contact bars 220a and 220b are preferably elastically supported so as to be rotated from the fixing member 210 toward the front glass by the spring 240 wound around the outer circumference of the first hinge pin 230 on the left and right sides, respectively.

The first hinge pin 230 is simultaneously connected between the first pin support protrusion 216 protruding from the rear left and right sides of the upper surface of each of the pair of first fixing members 212a and 212b at the rear of the upper surface thereof and the second pin support protrusion 222 protruding from the left and right sides of the lower front of each of the pair of left and right window contact bars 220a and 220b to support the spring 240.

The spring 240 may have one side end connected to the left and right sides of the upper end of the fixing member 210, respectively, and the other side end connected to the front surface of the pair of left and right window contact bars 220a and 220b.

The second hinge pin 250 is connected between the second pin support protrusions 222 which protrude to the left and right sides of the lower front of the second fixing member 214 and serves to connect the rear of the rotating member 260.

The rotary member 260 is rotatably installed at a central front of the fixed member 210 by a second hinge pin 250 and serves to be connected to the rear portions of the connection covers 120 and 130 through the connection member 270.

At least one additional connection member 280 is connected to a front side of the connection member 270 in a T-shaped concavo-convex form so as to be inserted and fixed into the connection covers 120 and 130.

The hold mount 300 includes a magnetic type fixed mount 310, a screw type fixed mount 320 for a camera, and a general fixed mount 330, which are detachably connected to the front of the dashboard mount 100 via a connector 150 and configured to mount a media device 340 thereon.

The support part 400 serves to connect the lower surface of the body 110 and the rear lower part of the media device 340, and includes a cable 410 connected in the longitudinal direction of the lower surface of the body 110 and a head 420 formed in front of the cable 410 to support the rear lower part of the media device 340.

As such, since the mount for a vehicle media device according to the present invention has a structure in which the driver may push the holder toward the front glass in a state in which the holder is extended and inserted into a slight gap portion formed between the front glass and the dashboard of the vehicle, the holder may be stably fixed between the front glass and the dashboard by the force of the spring 240 to hold the media device 340, and thus, it is possible to easily hold the media device 340 using various hold mounts 300 while preventing unnecessary marks from being generated in the vehicle, and it is possible to improve safety during driving of the vehicle by minimizing a portion of the front glass of the vehicle that blocks a field of view.

Meanwhile, the present invention is not limited to the above-described embodiments, but may be modified and modified within a range without departing from the gist of the present invention, and it should be considered that the modified and modified technical spirit also belongs to the following claims.

What is claimed is:

1. A mount for a vehicle media device, comprising:
a dashboard mount (100);
a fixing bracket (200) rotatably connected to the rear of the dashboard mount (100);
a lower portion inserted into and fixed to a gap between a front glass and a dashboard of a vehicle;
an upper portion closely fixed to the front glass; and
a hold mount (300) connected to the front of the dashboard mount (100) to hold a media device (340).

2. The mount of claim 1, wherein the dashboard mount (100) comprises:
a body (110) of a predetermined length;
connection covers (123, 130) connecting the rear of the body (110) and one side of the fixing bracket (200); and
a connector (150) detachably connecting the front of the body (110) and the hold mount (300).

3. The mount of claim 1, wherein the body (110) has flexibility to be bent in a vertical direction.

4. The mount of claim 1, wherein the body (110) has flexibility to be bent in a vertical direction.

5. The mount of claim 2, wherein the connection covers (120, 130) comprise:
an upper cover (120) that encloses around the rear upper surface and both sides of the body (110); and
a lower cover (130) coupled to the lower portion of the upper cover (120) that is close contact with the rear lower surface of the body (110).

6. The mount of claim 5, wherein the upper cover (120) and the lower cover (130) are joined each other by a fastening screw (140) fastened to a lower portion of the lower cover (130).

7. The mount of claim 2, wherein a support part (400) is installed to connect a lower surface of the body (110) and a lower portion of a rear side of the media device (340).

8. The mount of claim 7, wherein the support part (400) includes:
a cable (410) connected to the body (110) in the longitudinal direction of the lower surface thereof; and
a head (420) formed at a front side of the cable (410) to support a lower portion of a rear side of the media device (340).

9. The mount of claim 1, wherein the fixing bracket (200) comprises:
a fixing member (210) having a lower portion inserted into and fixed to a gap between the front glass and the dashboard of the vehicle;
a pair of left and right window contact stands (220a, 220b) rotatably installed on the left and right sides at an intermediate height of the fixing member (210) to be in close contact with the front glass; and
a rotation member (260) rotatably installed at a center front at an intermediate height of the fixing member (210) to be connected to the rear of the connection covers (120, 130) via a connection member (270).

10. The mount of claim 9, wherein the fixing member (210) further includes:
a pair of left and right first fixing members (212a, 212b) formed horizontally from left and right sides of a vertical upper end of the fixing member (210) to a front side; and
a second fixing member (214) formed vertically upward between the pair of left and right first fixing members (212a, 212b) with respect to the vertical upper end of the fixing member (210).

11. The mount of claim 10, wherein:
the left and right sides of the front portion of the lower portion of the second fixing member (214) and the rear portion of the rotating member (260) are connected by a second hinge pin (250), and
the front portion of the rotating member (260) and the rear portion of the connecting member (270) are connected by screwing.

12. The mount of claim 9, wherein:
the lower front portions of the pair of left and right window contact bars (220a, 220b) and the upper rear portion of the fixing member (210) are connected to the left and right sides via a first hinge pin (230), and
the pair of left and right window contact bars (220a, 220b) are elastically supported so as to be rotated from the fixing member (210) toward the front glass by springs (240) wound around outer circumferences of the first hinge pin (230) at the left and right sides, respectively.

13. The mount of claim 12, wherein:
each one end of the spring (240) is connected to the left and right sides of the upper end of the fixing member (210), and
the other end of the spring (240) is connected to front surfaces of the pair of left and right window contact bars (220a, 220b).

14. The mount of claim 9, wherein at least one additional connection member (280) is connected to a front side of the connection member (270) in a T-shaped concavo-convex shape so as to be inserted and fixed in the connection covers (120, 130).
